(19) United States
(12) Patent Application Publication
(10) Pub. No.: US 2014/0318892 A1
(43) Pub. Date: Oct. 30, 2014

(54) MANUALLY POWERED LINKAGE LADDER

(71) Applicant: CATERPILLAR INC., Peoria, IL (US)

(72) Inventors: Thomas Meyen, Clinton, IL (US); Riley Albers, Decatur, IL (US); Jared E. Louis, Monticello, IL (US)

(73) Assignee: Caterpillar Inc., Peoria, IL (US)

(21) Appl. No.: 13/873,493

(22) Filed: Apr. 30, 2013

(51) Int. Cl. E06C 5/22

(52) U.S. Cl. CPC E06C 5/22
USPC 182/127

(57) ABSTRACT

A four-bar linkage ladder is used to provide access to the cab of a mobile machine. The ladder is light enough for manual operation and may include a spring assembly, but avoids the need for the electric, pneumatic, or hydraulic actuators of prior art moveable ladders. The ladder swings from bumper height to an ergonomically desirable height for access and egress and allows passage over uneven terrain without ground contact.

### TECHNICAL FIELD

The present disclosure is directed to an access system for mobile machines and more specifically to a linkage ladder for use in connection with mobile machines.

### BACKGROUND

Most mobile machines or other heavy equipment, from construction and mining machines to agricultural equipment, have some form of access system to assist an operator in gaining access to an operator station or cab. For example, some trucks are accessible only via a ladder or stairs located at the front bumper.

These access systems take two general forms. The first is a rigid ladder attached to the machine, such as at the bumper. In one such arrangement, the ladder is permanently fixed to a bumper and extends below the bumper. Because the ladder extends below the bumper and the overall ground clearance of the machine, the ladder can both be damaged by an obstruction and cause damage to an object when encountered.

The second form of access system is a moveable staircase that uses electric, pneumatic, or hydraulic lifts to position the staircase for use or to stow the staircase away from obstructions. The staircase is generally too heavy for manual operation and must rely on the lift for operation. Furthermore, because the machines are often parked at berms or with the tires in a ditch, unless the staircase is fully deployed the steps are left at an angle that may be at best unsafe and at worst case, unusable.

U.S. Pat. No. 4,425,983 discloses a four-bar fire escape ladder that is wall-mounted. The ladder uses a cam on an upright rail to hold the ladder in the up position. The ladder fails to disclose upper and lower lift handles and fails to disclose ergonomic lift areas for operator convenience and safety. The ladder also fails to disclose a baseplate for use in attaching the ladder to a mobile machine.

### SUMMARY OF THE DISCLOSURE

In one aspect of the present disclosure includes a ladder for use with a mobile machine, such as but not limited to, a loader, a dump truck, a grader, a paver, an articulated truck, an excavator, a mining shovel, and agricultural equipment. The ladder may include a first rail and a second rail with rungs connecting the first rail and the second rail, and a lift handle attached to the first support extending above a top rung to form a step assembly, the lift handle including a grip region at an upper portion of the lift handle. The ladder may also include a baseplate for use in fixedly attaching the ladder to the mobile machine, at least one four-bar linkage that moveably attaches the step assembly to the baseplate, and a latch fastened to the baseplate that engages a feature of the step assembly when in an up position.

In another aspect of the present disclosure, a method of using a ladder fixedly attached to a mobile machine include providing a ladder having at least one four-bar linkage with opposite linkages being approximately equal in length, a step assembly, a guide having a groove and a stop, a lift handle attached to the step assembly, and a latch. The method may also include receiving a hand motion that releases the latch, lowering the step assembly, and engaging one of the linkages in the groove of the guide. The method also may include raising the step assembly by the lift handle, engaging at least one of the linkages against the stop of the guide, and engaging the latch at a feature of the step assembly.

In yet another aspect, a machine may include a bumper, grab rails attached to the bumper, and a ladder mounted between the grab rails. The ladder may include a first rail and a second rail, rungs connecting the first rail and the second rail and a lift handle attached to the first rail extending above a top rung, the lift handle, rungs, first rail and second rail forming a step assembly, a baseplate for use in fixedly attaching the ladder to the bumper, and at least four-bar linkage that moveably attaches the step assembly to the baseplate.

### BRIEF DESCRIPTION OF THE DRAWINGS

FIG. 1 is a perspective view of a ladder in accordance with the current disclosure;

FIG. 2 is a perspective view of a portion of the ladder of FIG. 1 in an up position;

FIG. 3 is a perspective view of the ladder of FIG. 1 in a down position;

FIG. 4 is a side view of the ladder of FIG. 1 in an up position showing ergonomic lifting areas;

FIG. 5 is a side view of the ladder of FIG. 1 in a partially deployed position showing ergonomic lifting areas;

FIG. 6 is a side view of the ladder of FIG. 1 in a down position showing ergonomic lifting areas;

FIG. 7 is a perspective view of a ladder in an up position attached to a bumper of a mobile machine;

FIG. 8 is a perspective view of a ladder in a down position attached to a bumper of a mobile machine;

FIG. 9 is a perspective view of a latch suitable for use with the ladder of FIG. 1;

FIG. 10 is a perspective view of an alternate embodiment of a ladder in accordance with the current disclosure in an up position;

FIG. 11 is a perspective view of an alternate embodiment of the ladder of FIG. 10 in accordance with the current disclosure in a down position; and

FIG. 12 is a flowchart of a method of using a ladder on a mobile machine.

### DETAILED DESCRIPTION

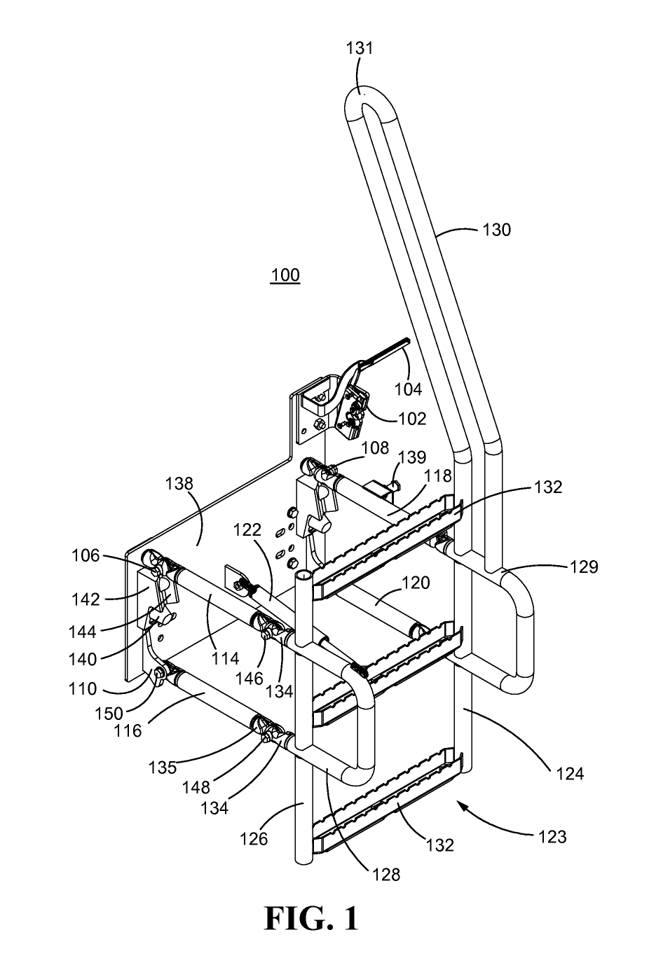

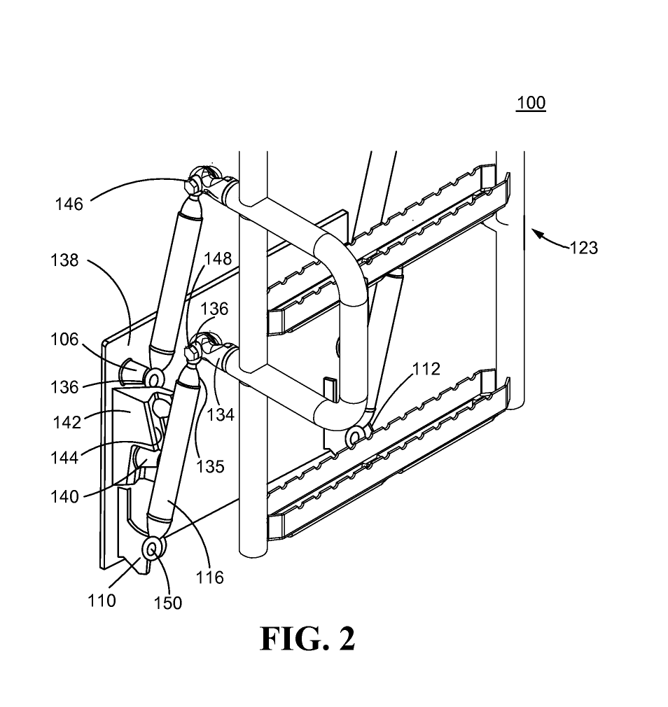

FIG. 1 and FIG. 2 illustrate a ladder 100 in perspective view, suitable for use on a mobile machine, that is, a mobile machine with enough ground clearance so than an operator cannot step directly into the cab or onto a bumper or other foothold. Ladder 100 includes a latch 102 with a release lever 104. The ladder 100 also includes a first hinge 106 and a second hinge 108, as well as a first gusset 110 and a second gusset 112. The first hinge 106 may be formed by a male connector and a female connector, discussed more below, used to attach a linkage 114 to a baseplate 138. Similarly, the second hinge 108 may be used to attach a linkage 118 to the baseplate 138. The gussets 110 and 112 may be used to attach respective linkages 118 and 120 the baseplate 138. Ladder 100 may also include a spring assembly 122 that may optionally be used to assist raising and lowering the ladder 100.

A step assembly 123 may include a first rail 124, a second rail 126, and one or more handles 128, 129, and a lift handle 130 including a lift handle grip point 131. The step assembly 123 may also include rungs or steps, hereinafter referred to as rungs 132, attached on one end to rail 124 and on the other end to rail 126. There may be other variations of the exact relationship between these components, such as spacing of the rungs 132, the location of the handles 128, 129, etc. The first hinge 106 and first gusset 110 at hinge 150 define a ground link 115 (see FIG. 5) in a four-bar linkage. The first hinge 106 and the hinge 150 may be referred to as baseplate hinges. A coupler link 117 (see FIG. 5) is formed by the handle 128 between a hinge 146 and a hinge 148 (the support hinges). The ground link 115 and coupler link 117 form two sides of a first four-bar linkage. The linkages 114 and 116 form the other two sides of the first four-bar linkage. In order to keep the step assembly 123 in the same orientation with the baseplate 138 throughout a deployment cycle of the ladder 100, the ground link 115 and coupler link 117 are approximately equal in length as are the linkages 114 and 116. That is, the opposite sides of the four-bar linkage are generally equal in length even if the adjacent sides of the four-bar linkage are not equal in length. While the ideal four-bar linkage would have opposite sides exactly equal, at least manufacturing and assembly tolerances may combine in such a manner that the opposite sides are only approximately equal but still within the field of the current disclosure. In other embodiments, some intentional deviation from a perfect parallelogram four-bar linkage may be desired, for example, to allow water to drain from a step during deployment without making the step unusable if deployed only half way.

A second four-bar linkage may be formed by the second hinge 108, gusset 112, the second handle 129 and linkages 118 and 120. In an embodiment, each element (linkage) of this four-bar linkage is the same length as the corresponding elements of the first four-bar linkage.

A connector 134 may be installed respectively in each end of each linkage 114, 116, 118, 120. Additional connectors 135 may be installed in the upper and lower ends of each handle 128 and 129 and the top of baseplate 138. A bushing 136 may be installed at hinge 146 and at hinge 148 between connectors 134 and 135 at both ends of the linkages 114 and 118, as well as at the step assembly end of the linkages 116 and 120. In an embodiment, the connector 134 is male and has an insert that fits into the corresponding female element of connector 135. Of course, the connectors may be mixed as to the location of male and female connectors. In another embodiment, two female connectors may be used and a pin, rivet, or bolt may be used to mate the connectors.

Referring to FIG. 2, a bushing 136 may also be used at the contact point between the gussets 110, 112 and the connector 134 at the baseplate end of linkages 116 and 120. The bushings 136 may be made of nylon, polytetraflouroethylene (PTFE, such as Teflon® by DuPont), or another smooth compound to reduce friction and act as a wear surface at the moveable joints of the four-bar linkages, that is, where the respective connectors are joined.

In an alternate embodiment, a connector 134 may be used instead of the gussets 110, 112. In the illustrated embodiment, a flange of the gussets 110,112 may help provide additional support to the step assembly in the down position by contacting the linkages 116 and 120.

The connectors 134, 135 may have a cylindrical base with a shoulder. The cylindrical base may be inserted in baseplate 138, in the linkage ends, and in the handle ends. The shoulder may set the depth of the connectors 134 and serve as a weld point. A top of the connector 134, 135 may be a hemispherical with a flat side positioned to face the flat side of a corresponding connector 134, 135. During assembly of the handle 128, the baseplate 138, and the linkages 114, 116, 118, 120, simple jigs may be used to align the connectors 134, 135 to its respective work piece so that the corresponding components are self-aligning during final assembly.

A stop 140 may be installed in a guide 142 that itself is attached to the baseplate 138. The guide 142 may include a groove 144. The guide 142 and stop 140 interact with linkages 114 and 116 as discussed in more detail below. A second guide and stop may be installed to cooperate with the second four-bar linkage.

When the ladder 100 is in an up position, as shown in FIG. 2, the linkage 116 may engage the stop 140 just prior to the latch 102 being captured by a feature 139 (shown in FIG. 1), such as a pin, of the step assembly 123. The stop 140 may be constructed of a resilient material configured to apply an outward resistance pressure on the step assembly 123 against the latch 102 and may reduce rattling during operation of the mobile machine. The stop 140 may be installed in the angled face of guide 142 with a screw so that the stop 140 may be adjusted in and out to provide more or less pressure to the linkage 116 during latching, for example, to accommodate operating conditions, wear, and an amount of force required for the latch 102 to capture the step assembly 123. In an alternate embodiment, the stop 140 may be mounted in a slot (not shown) of an angled face of guide 142 so that the stop 140 may be moved up and down along the angled face and provide more or less pressure to the linkage 116 during latching. As discussed above, a second guide and stop may be installed to cooperate with second four-bar linkage on the other side of the step assembly 123.

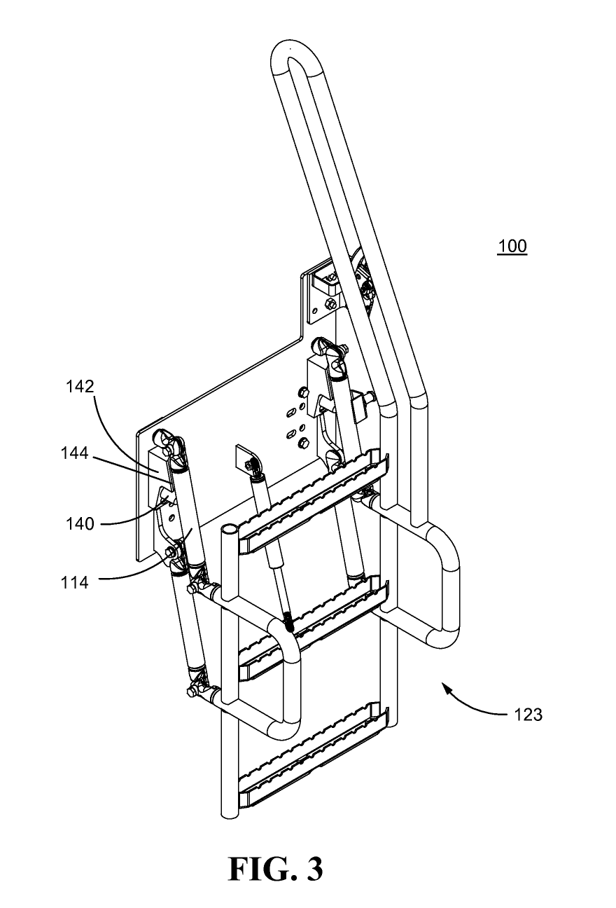

FIG. 3 illustrates the ladder 100 in the down position. In this position, the linkage 114 rests in the groove 144 of the guide 142. This not only provides a lower limit stop for the step assembly 123, but also provides side-to side-support to reduce wobble when the ladder 100 is in use in the down position.

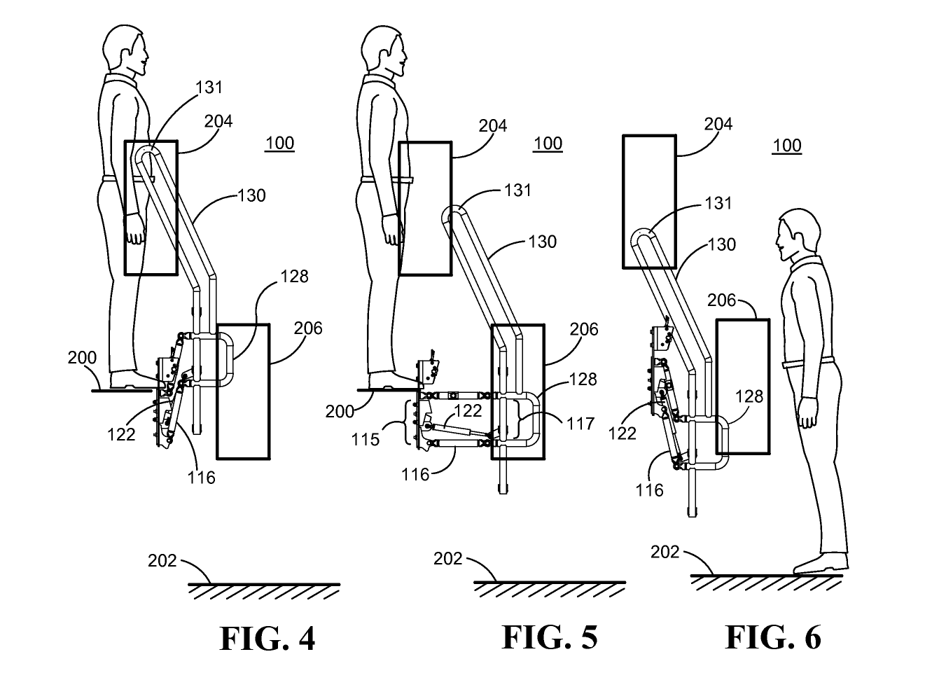

FIGS. 4-6 illustrate operation of ladder 100. A human representation in each figure shows the relative position of ladder components during deployment. The bumper 200 of the machine and ground level 202 are illustrated.

In FIGS. 4-6, ergonomic lift areas are illustrated by box 204 and by box 206 depending upon whether an operator is standing on the bumper 200 or at ground level 202. As shown, both the lift handle grip point 131, that is, the top of the lift handle 130 and at least some portion of the handle 128 or 129 are configured to be located in the respective ergonomic lift areas. This allows the operator to raise and lower the ladder 100 from either ground level 202 or the bumper 200 while maintaining control of the ladder 100 from an ergonomically desirable position.

Further to FIGS. 4-6, the side view of each figure illustrates the relative position of the linkages, for example linkage 116, in relationship to the spring assembly 122. In the fully up position shown in FIG. 4, the spring assembly 122 and the linkage 116 are virtually parallel so that force applied by the spring assembly 122 toward the baseplate 138 will have little or no leverage on the step assembly 123 in a downward direction.

FIG. 5 illustrates that midway through the travel of the step assembly 123 (up or down) an angle is formed between the spring assembly 122 and the linkage 116 so that the spring assembly 122 provides a counterbalance force to the step assembly 123.

FIG. 6 illustrates that at the bottom of the travel of the step assembly 123 the spring assembly 122 is again virtually parallel with the linkage 116, and again, the force of spring assembly 122 does not provide any leverage to the step assembly 123. In one embodiment, the force imparted by the spring assembly 122 will not prevent the ladder 100 from dropping to its fully down position so that if the latch 102 fails, the ladder 100 will deploy on its own and fail in the down position. In an embodiment, the force of the spring assembly 122 may be selected so that the maximum force required at any point in the deployment cycle is about 70-130 Newtons, or more particularly, about 95-105 Newtons. The spring assembly force required may be calculated using the mass of the step assembly 123 and linkages as well as the maximum angle between the spring assembly 122 and a linkage 114, selected for the purpose of illustration. Simple trigonometry allows development of a vertical component of force needed to provide the desired counterforce for the downward gravitational force on the step assembly 123.

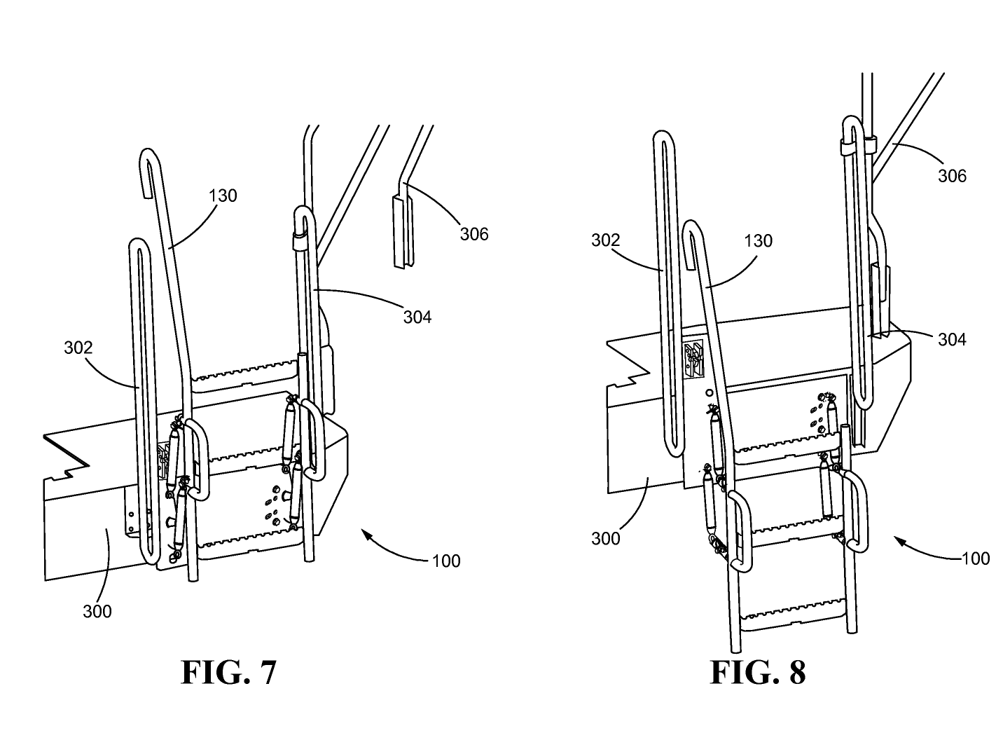

FIG. 7 is a perspective view of the ladder 100 in an up position mounted to the bumper 300 of a machine (not fully shown). The machine to which the bumper 300 is attached may be a loader, a dump truck, a grader, a paver, an articulated truck, an excavator, a mining shovel, agricultural equipment, etc. In some embodiments, the ladder 100 may not be attached to a bumper but instead may be attached to another part of the machine.

As illustrated in FIG. 7, the ladder 100 may be attached to a bumper 300. A left grip 302 and a right grip 304 may be permanently mounted to the bumper 300 on either side of the ladder 100. Once on the bumper 300 an operator may continue up a fixed staircase (not shown) using a staircase railing 306 to access a cab of the machine. As shown, a lift handle 130 may only be present on a side of the ladder 100 away from the fixed staircase railing 306 so that the lift handle 130 does not interfere with an operator ascending or descending the staircase. As illustrated here, the lift handle 130 is configured as an umbrella handle as opposed to the full loop shown in FIG. 1. In other embodiments, lift handle 130 may be provided on both rails 124 and 126. In some embodiments, this is not necessary because the grips 303, 304 can provide required points of contact so that the lift handle 130 is not required as a handhold during ladder use. That is, the lift handle 130 can serve only to raise and lower the ladder 100 when the operator is on the bumper 300.

FIG. 8 is similar to FIG. 7 with the ladder 100 in the down position. The distance from the top of the bumper 300 to the bottom rung 132 when the step assembly 123 is fully down is the total drop of the ladder 100. The total drop is a function of the length of the linkages 114, 116, 118, 120. In an embodiment, the step height is between 350 mm and 450 mm above the ground or more particularly between 390 mm and 410 mm Other step heights may be used based on design constraints and applicable regulations. As the total drop is increased, an angle of the lift handle 130 may be increased to keep the lift handle from extending too far out over the edge of the bumper 300 during deployment of the ladder 100. From the ground, an operator can simply step back if the swing path of the step assembly 123 requires it.

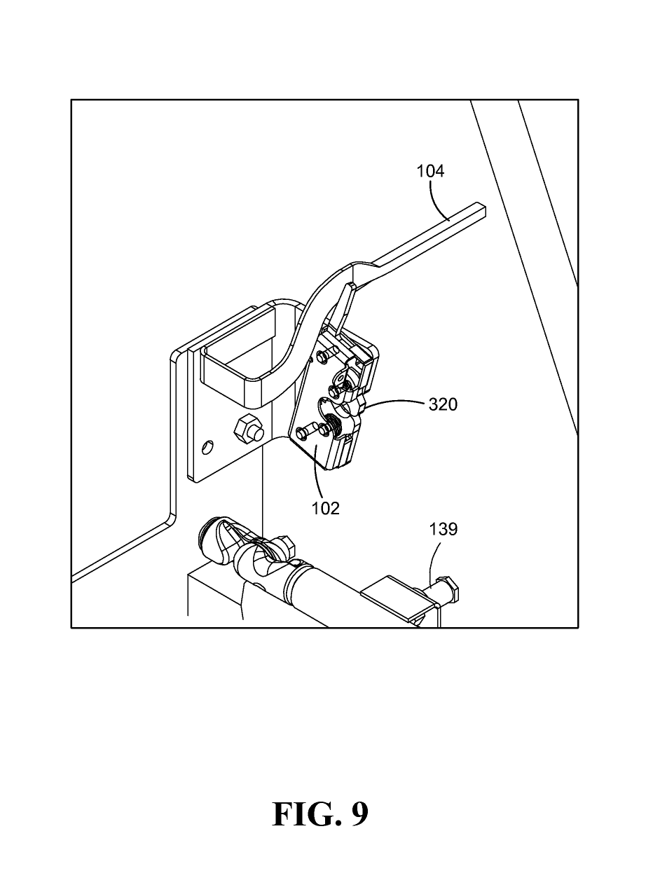

FIG. 9 illustrates a latch 102 and release lever 104. The latch 102 can include a double jaw mechanism 320 as shown or any number of other locking mechanisms known in the art. The latch 102 may engage the feature 139, such as a pin to hold the step assembly 123 in the up position and the double jaw mechanism 320 may open to release the feature 139. The release lever 104 shown may provide convenient activation both by hand, when an operator is standing on the ground, or by a shoe or boot when an operator is standing on the bumper 300.

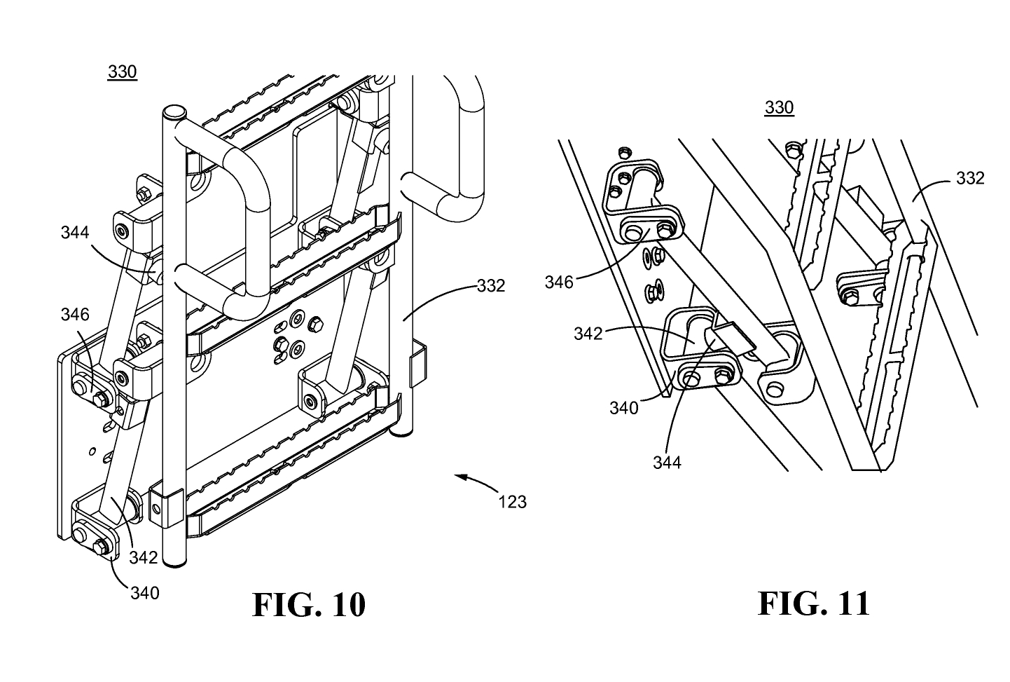

FIG. 10 and FIG. 11 show perspective views of another embodiment of a ladder 330. The ladder 330 may include a step assembly 332. In this embodiment, a hinge mount 340 is used on both ends of a dog bone linkage 342. A bushing 346 may be used to reduce friction and act as a wear surface between the hinge mount 340 and the dog bone linkage 342. The remaining joints of the ladder 330 may be similarly connected.

When in an up position, as shown in FIG. 10, a stop 344 may contact the step assembly 332. Similar to that of the embodiment described above, the stop 344 may provide an outward resistance pressure as the latch 102 is engaged to reduce vibration while the ladder 330 is stowed. In the down position, shown in FIG. 11, the stop 344 may contact a lower one of the dog bone linkages 342 and provide a soft stop when deploying the ladder 330. In this embodiment, side-to-side support is provided by the wide base of the dog bone linkage 342.

### INDUSTRIAL APPLICABILITY

The ladder 100 may be used on a variety of machines, including but not limited to, a loader, a dump truck, a grader, a paver, an articulated truck, an excavator, a mining shovel, and agricultural equipment. Because it is manually operated, the ladder 100 is readily available and does not depend on power from an external source, such as, hydraulic, electric, or pneumatic power from the machine or an external source. Because the ladder 100 stows at or near bumper height, the overall ground clearance of the machine is improved over fixed ladders. The four-bar linkage construction allows the ladder 100 to remain at a nearly constant angle throughout the deployment so that if the ladder cannot be fully lowered, it is still usable at whatever height it becomes obstructed. In an embodiment, the linkages 114, 116, 118, 120 may be of a length that even at a maximum distance from the bumper 300, see, e.g., FIG. 5, the ladder 100 may be safely reached by stepping from the bumper 300.

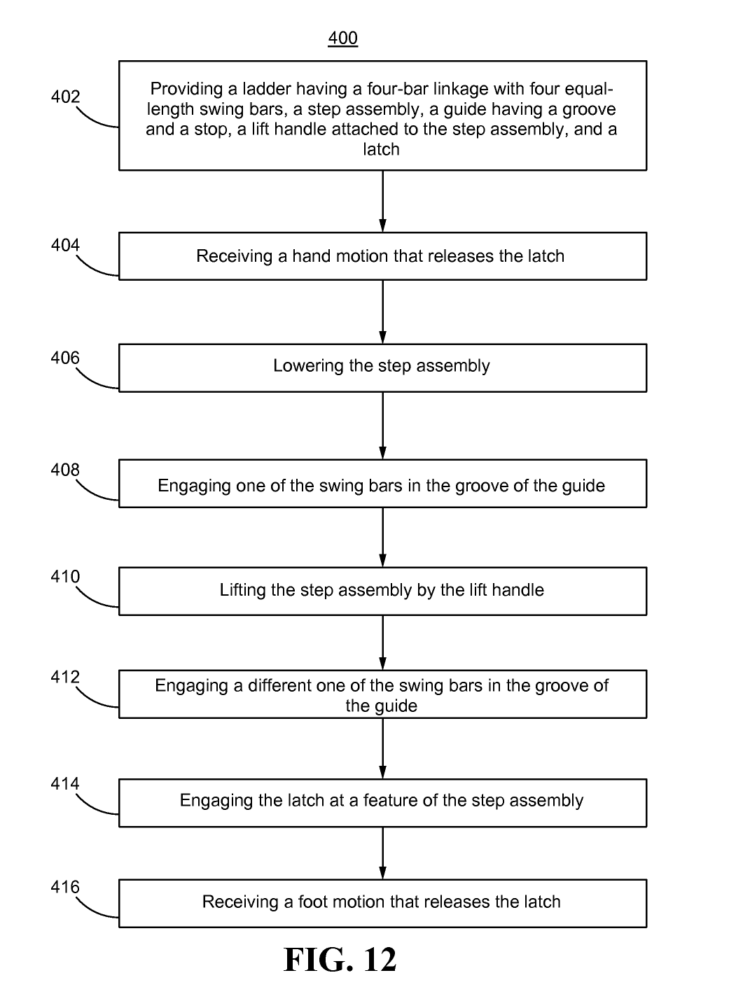

Referring to FIG. 12, a method 400 of using a linkage ladder 100 for accessing a machine is discussed and described. At block 402, the ladder 100 may be provided, including four linkages 114, 116, 118, 120, that may be equal in length, a step assembly 123, a guide 142 having a groove 144 and a stop 140, a lift handle 130 attached to the step assembly 123, and a latch 102.

At block 404, a hand motion that releases the latch 102 may be received at a release lever 104 of the latch 102. The release lever 104 is operable by hand, with a tool, or with a shoe or boot.

After operating the release lever 104 to unlock the latch 102, the step assembly 123 may be lowered at block 406. If the step assembly 123 cannot be fully deployed, such as when there is an obstruction under the bumper 300, the step assembly 123 remains at a constant orientation and can be used at any height.

At block 408, when in the down position, one or more of the linkages 114, 116, 118, 120 may be engaged in the groove 144 of its respective the guide 142. At block 410, after being deployed in the down position, the ladder 100 may be lifted by either a handle 128 or the lift handle 130. In an alternate embodiment, additional hinges, such as first hinge 106 and second hinge 108 and additional guides and stops, such as guide 142 and stop 140 may be installed instead of the gussets 110 and 112 to provide additional side-to-side stability and weight-bearing capacity. In yet another embodiment, the gussets 110, 112 and the hinges 106, 108 may be reversed so that the gussets 110, 112 are above the hinges 106, 108. In yet another embodiment, a guide 142 and stop 140 may be installed under the spring assembly 122 to provide additional side-to-side stability and support for the step assembly 123 when in the down position.

At block 412, at least one of the linkages may be engaged against the stop 140. At block 414, the latch 102 may engage a feature of the step assembly, such as a pin, knuckle, barb, etc. to lock the ladder 100 in the up position. At block 416, a foot motion may be received at the release lever to open the latch and allow the ladder 100 to be deployed.

The baseplate 138 provides a single mounting point for the ladder as opposed to some four-bar linkage ladders that have multiple attachment points, for example, for wall mounting. When drilled at standard offsets, holes in the baseplate 138 can allow use on any machine that accommodates the standard holes so that the ladder 100 may be used in aftermarket applications as well as in new designs. To accommodate slight mounting variations, some or all of the mounting holes may be slotted to allow for adjustment. Similarly, the mounting holes in the baseplate for the guide 142 may be slotted to accommodate different materials, different diameter linkages 114, and to account for wear of the components.

What is claimed is:

1. A ladder for use with a mobile machine, the ladder comprising:
a first rail and a second rail;
rungs connecting the first rail and the second rail and a lift handle to form a step assembly, the lift handle attached to the first rail extending above a top rung wherein the lift handle includes a grip region at an upper portion of the lift handle;
a baseplate for use in fixedly attaching the ladder to the mobile machine;
at least one four-bar linkage that moveably attaches the step assembly to the baseplate; and
a latch fastened to the baseplate that engages a feature of the step assembly when in an up position.

2. The ladder of claim 1, wherein the latch comprises a release lever.

3. The ladder of claim 1, wherein the baseplate has slotted mount for attachment of the latch.

4. The ladder of claim 1, wherein the baseplate has a slotted mount for attaching a guide.

5. The ladder of claim 1, wherein the at least one four-bar linkage comprises:
two first support hinges attached to the first rail and vertically separated by a distance;
two first baseplate hinges attached to the baseplate and vertically separated by the distance; and
a set of linkages connecting respective support hinges to respective baseplate hinges, each linkage of the set of linkages being equal in length.

6. The ladder of claim 5, further comprising a guide attached to the baseplate, the guide including a groove that engages a first linkage of the set of linkages when the step assembly is in a down position.

7. The ladder of claim 6, wherein the guide includes a stop arranged to apply an outward pressure on one of a second linkage of the set of linkages and the step assembly while the step assembly is captured by the latch.

8. The ladder of claim 5, further comprising a set of bearings, one bearing disposed in each support hinge and each baseplate hinge.

9. The ladder of claim 5, wherein a bottom baseplate hinge is attached to the baseplate via a gusset.

10. The ladder of claim 9, wherein a top baseplate hinge is attached to the baseplate via a connector.

11. The ladder of claim 1, further comprising a spring assembly mounted between the baseplate and the step assembly.

12. The ladder of claim 11, wherein the spring assembly provides less lift to the step assembly than a weight of the step assembly, so that the step assembly assumes a down position absent capture of the step assembly by the latch.

13. The ladder of claim 12, wherein the spring assembly in side view is generally parallel with a linkage of the at least one four-bar linkage when the step assembly is in both the up position and a down position.

14. The ladder of claim 1, wherein the step assembly further comprises a handle attached to at least one of the first rail and the second rail.

15. A method of using a ladder fixedly attached to a mobile machine, the method comprising:
providing the ladder having at least one four-bar linkage with opposite linkages of the at least one four-bar linkage being approximately equal in length, a step assembly including a lift handle, a guide having a groove and a stop, and a latch;
receiving a hand motion that releases the latch;
lowering the step assembly;
engaging a linkage of the at least one four-bar linkage in the groove of the guide;
raising the step assembly by the lift handle;
engaging a linkage of the at least one four-bar linkage against the stop of the guide; and
engaging the latch at a feature of the step assembly.

16. The method of claim 15, further comprising receiving a foot motion that releases the latch.

17. The method of claim 15, wherein the step assembly includes a handle attached to the step assembly and the method further comprises maintaining at least a portion of the lift handle and at least a portion of the handle within separate upper and lower ergonomically defined zones throughout lowering the step assembly.

18. The method of claim 15, further comprising maintaining the step assembly parallel to a baseplate connected to the step assembly by the at least one four-bar linkage throughout lowering the step assembly.

19. A machine comprising:
a bumper;
grab rails attached to the bumper;
a ladder mounted between the grab rails, the ladder including:
a first rail and a second rail;
rungs connecting the first rail and the second rail;
a lift handle attached to the first rail extending above a top rung, the lift handle including a grip region at an upper portion of the lift handle, the lift handle, rungs, the first rail, and the second rail forming a step assembly;
a baseplate for use in fixedly attaching the ladder to the bumper; and
at least one four-bar linkage that moveably attaches the step assembly to the baseplate.

20. The machine of claim 19, wherein the ladder further comprises a latch fastened to the baseplate that engages a feature of the step assembly when in an up position, the latch also including a release lever operable manually.
